(19) United States
(12) Patent Application Publication
(10) Pub. No.: US 2012/0103099 A1
(43) Pub. Date: May 3, 2012

(54) LASER VIBRATION SENSOR, SYSTEM AND METHOD

(76) Inventors: Michael J. Stuke, Palo Alto, CA (US); Shih-Yuan (SY) Wang, Palo Alto, CA (US)

(21) Appl. No.: 12/916,484

(22) Filed: Oct. 29, 2010

(51) Int. Cl. G01N 21/41; B82Y 99/00

(52) U.S. Cl. 73/657; 977/956

(57) ABSTRACT

A laser vibration sensor, system and method of vibration sensing employ a nanostructured resonance interactor. The sensor includes a resonator cavity of a laser and the nanostructured resonance interactor. The resonator cavity has a resonance deterministic of a characteristic of an output signal of the laser. The nanostructured resonance interactor modulates the resonance of the resonator cavity in response to a vibration. A change in the output signal characteristic induced by a resonance modulation is representative of the vibration. The system further includes an output signal detector. The method includes modulating a resonance characteristic of the resonator cavity using a nanostructure that responds to the vibration being sensed.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Vibration sensors of various kinds including, but not limited to, accelerometers of various designs and configurations, velocity sensors, and geophones as well as other related acoustic transducers, are used in a wide variety of applications ranging from exploration to intrusion detection and perimeter defense. For example, an array of seismic sensors (e.g., geophones or accelerometers) that sense vibrations in the soil and subsurface layers of the earth may be deployed over a field in support of subsurface exploration activities. Similar seismic sensor arrays are routinely used to monitor naturally occurring seismic waves due to one or more of volcanic activity, tectonic movements (e.g., earthquakes), and other natural processes. In another example, the motion of bridges and other structures, either due to normal operation of the structure or induced on or within the structure by outside forces, may be monitored and even controlled using inputs from an array of vibration sensors. Likewise, vibration sensors deployed within a defensive perimeter or along a border may facilitate the detection of intruders as well as monitoring other activities associated with the perimeter or border, for example.

Often vibration sensors are employed in remote locations. Retrieving data from the vibration sensors can often present a challenge. In addition, whether considering vibration monitoring of remote locations or local environments, the vibration sensing may be conducted in relatively harsh or otherwise caustic environment. Optical vibration sensors (e.g., laser vibration sensors) are often well suited to such remote and/or hostile environments. Examples of such optical or laser vibration sensors include those that employ microelectromechanical systems (MEMS) mirrors to deflect an output signal of a laser. Unfortunately, such MEMS laser vibration sensors may be relatively fragile and may be difficult to manufacture given the relatively tight tolerances required in the optical alignment of the MEMS mirrors that are used. Fragility and tight tolerances can limit the application of MEMS laser vibration sensors in some instances. Other laser vibration sensors that employ various effects including, but not limited to, crystal strain within a lasing material may suffer from poor sensitivity and low dynamic range issues.

### BRIEF DESCRIPTION OF THE DRAWINGS

The various features of examples may be more readily understood with reference to the following detailed description taken in conjunction with the accompanying drawings, where like reference numerals designate like structural elements, and in which:

FIG. 1 illustrates a block diagram of a laser vibration sensor, according to an example of the principles described herein.

FIG. 2 illustrates a side view of a laser vibration sensor, according to an example of the principles described herein.

FIG. 3 illustrates a side view of a laser vibration sensor, according to an example of the principles described herein.

FIG. 4 illustrates a cross sectional top view of a laser vibration sensor, according to another example of the principles described herein.

FIG. 5 illustrates a perspective view of a laser vibration sensor, according to another example of the principles described herein.

FIG. 6 illustrates a perspective view of a laser vibration sensor, according to another example of the principles described herein.

FIG. 7 illustrates a block diagram of laser vibration sensor system, according to an example of the principles described herein.

FIG. 8 illustrates a flow chart of a method of vibration sensing, according to an example of the principles describe herein.

Certain examples have other features that are one of in addition to and in lieu of the features illustrated in the above-referenced figures. These and other features are detailed below with reference to the preceding drawings.

### DETAILED DESCRIPTION

Embodiments provide vibration sensing using a laser. In particular, vibration sensing and measurement employ a resonance of a resonator cavity of a laser, according to various examples. The resonance is modulated according to the vibration. The resonance modulation induces a change in a characteristic of an output signal of the laser. The change induced in the output signal characteristic facilitates measuring the vibration. Since the vibration measurement is based on changes induced in the output signal characteristic, a laser vibration sensor according to the principles described herein transmits or communicates a measurement of the vibration in a manner that is integrally associated with the output signal. In other words, the measurement is communicated ‘optically’ since the output signal of the laser is substantially optical in nature. Optical measurement communication may facilitate remote sensing, especially in hostile environments, according to some examples. Moreover, the laser vibration sensor is substantially integrated with the laser. Such integration may obviate the need for optical components used as vibration/acceleration sensing agents (e.g., a movable mirror or similar deflection structures) that are external to the laser, according to some examples. The lack of sensing agents external to the laser may enhance a ruggedness and reliability of the laser vibration sensor, according to some examples.

The laser employed for vibration sensing as described below may be substantially any laser and specifically any laser configuration. In particular, according to various examples, the laser may operate in any of a variety of laser modes and may comprise any of a variety of resonator configurations. For example, the laser may be a continuous mode laser that produces a continuous wave (CW) output signal. In other examples, the laser may exhibit another laser mode including, but not limited to, pulsed operation, q-switching, modelocking and pulsed pumping. Likewise, the resonator cavity of the laser may comprise any of a variety of resonator cavity types including, but not limited to, a Fabry-Perot resonator, a ring resonator and a disc resonator. Moreover, the laser may be of any laser type including, but not limited to, a semiconductor laser (e.g., diode laser), a gas laser, a ring laser, a fiber laser and a disc laser.

Examples of vibration sensing using a laser as described herein employ a resonance interactor. A ‘resonance interactor’ is defined herein as a means for interacting with and thus affecting a resonance of a resonant cavity of a laser that specifically excludes structures of or that make up the resonant cavity itself. In particular, the resonance interactor explicitly does not include mirrors or similar structures that define or otherwise establish the resonator cavity of a laser. Similarly, mirrors that change a direction of the resonant cavity are not resonance interactors, by definition herein. Thus, for example, a mirror of, e.g., at an end of, a Fabry-Perot resonator is not a resonance interactor, as defined and used herein. Instead, the resonance interactor, as defined and employed herein, interacts with an optical signal within the resonant cavity itself to affect the resonance. Further, the interaction primarily includes an effect other than a reflection. For example, the interaction may be in the form of a vibration-related change in one or more of an optical path length of the resonant cavity, an absorption or loss in the optical signal along the optical path, and a dispersion of the optical signal within the resonant cavity.

In addition, the resonance interactor as employed herein is explicitly defined as a ‘nanostructured’ resonance interactor. By ‘nanostructured’ it is meant that the resonance interactor comprises and employs a nanostructure (i.e., a nanoscale structure) to produce the interaction. As such and by definition, a portion of the nanostructured resonance interactor that interacts with the optical signal within the resonant cavity is a nanostructure having nanoscale dimensions.

The nanostructured resonance interactor may interact with or affect the resonance either directly or indirectly according to various examples. Direct interaction is defined as physically interfering with or equivalently modifying an optical field of an optical signal along or within an optical path within the resonant cavity. Generally, direct interaction employs a structure that intersects the optical path, for example. Indirect interaction is defined as affecting the optical field indirectly without physically intersecting the optical signal itself. For example, indirect interaction may interact with the optical signal through an evanescent or fringing field of the optical signal that extends outside of the optical path of the resonator cavity. Indirect interaction may be accomplished by coupling to an evanescent field of the optical signal, for example.

In various examples as mentioned above, the nanostructured resonance interactor comprises a nanoscale structure. In some examples, the nanostructure may generally comprise an elongated, nanoscale structure having a length that exceeds by more than several times a nanoscale cross sectional dimension (e.g., width) taken in a plane perpendicular to the length (e.g., length >2×width). In some examples, the length of the nanoscale structure is much greater than the width or cross sectional dimension. In some examples, the length (or height) exceeds the cross sectional dimension (or width) by more than a factor of 5 or 10. For example, the width of the nanoscale structure may be about 40 nanometers (nm) and the height may be about 400 nm. In another example, the width at a base of the nanoscale structure may be between 20 nm and 100 nm and the length may be more than about 1 micrometer (μm). In another example, the nanoscale structure may be conical with a base having a width of between 100 nm and 500 nm and a length or height that is between one and several micrometers. In other examples, the length is less than the width or cross sectional dimension. In yet other examples, the length and width are about equal. Such a nanoscale structure may be referred to as a nanowire or nanorod. However, other names such as nanocone or nanowhisker may apply equally well to nanoscale structures described herein.

In some examples, the nanostructured resonance interactor may comprise non-nanoscale elements or components in addition to the nanostructure(s). For example, the nanostructured resonance interactor may comprise a proof mass that is not nanoscale. The proof mass may be attached to the nanostructure, for example. Movement of the non-nanoscale proof mass may affect a movement of the nanostructure, for example. In other examples, the nanostructured resonance interactor comprises only nanoscale elements (e.g., a nanostructure and a nanoscale proof mass).

In various examples, the nanoscale structure of the nanostructured resonance interactor may be one or more of produced by an additive process (e.g., grown or printed), formed by an imprinting or molding process (e.g., nanoimprint lithography) and produced by a subtractive process (e.g. etching). For example, the nanoscale structure may be grown using a vapor-liquid-solid (VLS) growth process. In another example, the nanoscale structure may be produced using an etching process such as, but not limited to, wet etching and reactive ion etching, to remove surrounding material leaving behind the nanoscale structure. In another example, nanoimprint lithography may be used. Various techniques used in the fabrication of micro-electromechanical systems (MEMS) and nano-electromechanical systems (NEMS) are applicable to the fabrication of the nanoscale structure.

By definition herein, ‘nanoscale’ means a dimension that is generally less than about 1000 nanometers (nm). For example, a structure that is about 5 to about 100 nm in extent is considered a nanoscale structure. Further, as used herein, the article ‘a’ is intended to have its ordinary meaning in the patent arts, namely ‘one or more’. For example, ‘a resonator cavity’ means one or more resonator cavities and as such, ‘the resonator cavity’ explicitly means ‘the resonator cavity(ies)’ herein. Also, any reference herein to ‘top’, ‘bottom’, ‘upper’, ‘lower’, ‘up’, ‘down’, ‘front’, back', ‘left’ or ‘right’ is not intended to be a limitation herein. Herein, the term ‘about’ when applied to a value generally means plus or minus 10% unless otherwise expressly specified. Moreover, examples herein are intended to be illustrative only and are presented for discussion purposes and not by way of limitation.

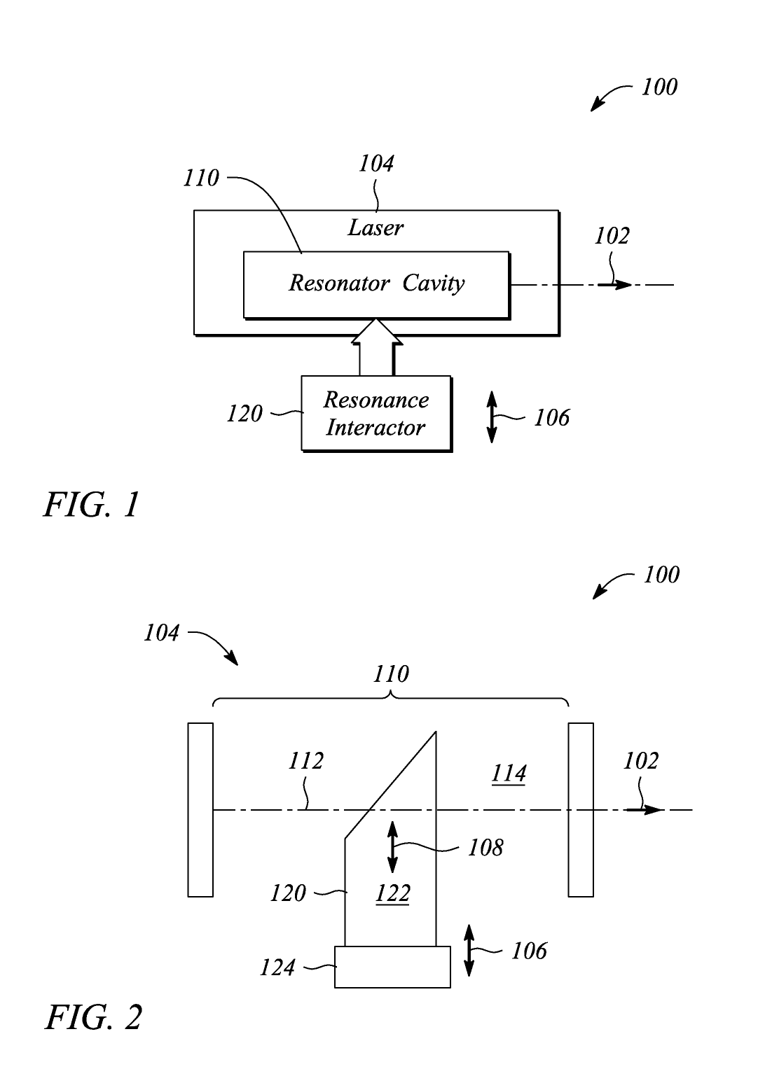

FIG. 1 illustrates a block diagram of a laser vibration sensor 100, according to an example of the principles described herein. The laser vibration sensor 100 produces a change in an output signal 102 of a laser 104 that is representative of the measured or sensed vibration 106, illustrated as a double-headed arrow in FIG. 1. The vibration-representative change in the output signal 102 can be used to measure the vibration experienced by the laser vibration sensor 100. The vibration 106 may be a vibration of or within a local environment of the laser vibration sensor 100, for example. In another example, the vibration 106 may represent an acceleration experienced by the laser vibration sensor 100. When the vibration 106 represents an acceleration, the laser vibration sensor 100 may be or act substantially as a laser accelerometer. A characteristic of the output signal 102 that is changed by the vibration (or equivalently by the acceleration) may include, but is not limited to, a frequency, a phase, a polarization and an amplitude or intensity of the output signal 102.

As illustrated in FIG. 1, the laser vibration sensor 100 comprises a resonator cavity 110 of the laser 104. The resonator cavity 110 exhibits or is characterized by a resonance. The resonance of the laser 104 is deterministic of a characteristic of the output signal 102 of the laser 104. That is, any change in the resonance induces a concomitant change in the output signal characteristic, as defined herein. For example, the characteristic of the output signal 102 may be frequency and the change in the resonance may induce a concomitant change in the frequency of the output signal 102.

In some examples, the laser 104 may comprise a laser gain material located between a pair of mirrors that form a Fabry-Perot resonator. In such examples, the resonator cavity 110 may comprise the Fabry-Perot resonator. In another example, the resonator cavity 110 comprises a ring resonator of a ring laser 104. In yet another example, the resonator cavity 110 may comprise a disc resonator. In some examples, the resonator cavity 110 may be substantially hollow (e.g., filled with a gas, a liquid or even containing a partial or even a substantial vacuum). For example, the laser 104 may be a gas laser. In other examples, the resonator cavity 110 may be substantially filled as is the case in a solid-state laser (e.g., a diode laser). In other examples, a gain media be a liquid or a solid and may partially or completely fill the resonant cavity 110.

The laser vibration sensor 100 further comprises a nanostructured resonance interactor 120. The nanostructured resonance interactor 120 modulates the resonance of the resonator cavity 110 in response to the vibration 106. In some examples, the nanostructured resonance interactor 120 directly interacts with an optical signal within the resonator cavity 110. In particular, the nanostructured resonance interactor 120, or a portion thereof, is located within the resonator cavity 110 to directly interact with an optical signal in the resonator cavity 110. For example, the nanostructured resonance interactor 120 may comprise a nanostructure that intersects an optical path of or within the resonant cavity 110. In examples in which the resonant cavity 110 is partially or completely filled with a solid material (e.g., a semiconductor laser), a slot or cavity may be formed or otherwise provided in a material of the resonator cavity 110 to accommodate the nanostructured resonance interactor 120 and to further facilitate motion thereof in response to the vibration.

Motion of the nanostructure of the nanostructured resonance interactor 120 in response to the vibration 106 may change or modulate one or more of a loss of the resonator cavity 110, a gain of the resonator cavity 110, a quality factor or ‘Q’ of the resonator cavity 110, and an effective optical length of the resonator cavity 110. For example, the motion may cause an effective length of the optical path to varying around a mean value. The change in the effective length may be reflected in a change in a mode or modes of the resonator cavity 110 that, in turn, results in a change in a frequency of the output signal 102, according to some examples. In other examples, the vibration-associated motion of the structure may affect one or more of an amplitude, a phase or a polarization of the optical signal of the optical path within the resonator cavity 110.

In other examples, the nanostructured resonance interactor 120 may indirectly interact with the optical signal within the resonator cavity 110. Specifically, the nanostructured resonance interactor 120 may comprise a movable structure adjacent to but substantially outside of the resonant cavity 110. In some of these examples, the nanostructured resonance interactor 120 may couple to an evanescent field of the optical signal of the resonant cavity 110. Motion of the nanostructured resonance interactor 120 induced by the vibration 106 changes the coupling. Changes in the coupling, in turn, affect one or more characteristics (e.g., frequency, phase, amplitude, polarization, etc.) of the output signal 102 produced by the laser 104.

In some examples, the nanostructured resonance interactor 120 is operably connected to a proof mass. The proof mass is configured to respond to the vibration 106. In some examples, the proof mass is connected to, but separate and distinct from, the nanostructured resonance interactor 120. For example, the proof mass may be a mass affixed to an end of a structure of the nanostructured resonance interactor 120. When the proof mass moves due to the vibration 106, the structure of the nanostructured resonance interactor 120 moves in a like manner due to the operable connection, for example. In other examples, either there is no proof mass or the proof mass is a portion of the nanostructured resonance interactor 120 itself. For example, an end of the structure of the nanostructured resonance interactor 120 may serve as the proof mass.

FIG. 2 illustrates a side view of a laser vibration sensor 100, according to an example of the principles described herein. In particular, as illustrated in FIG. 2, the nanostructured resonance interactor 120 comprises a nanostructure 122 (e.g., a nanowire) that is configured to intersect the optical path 112 of the resonator cavity 110. As illustrated by way of example, the nanostructure 122 has a wedge shape. The nanostructure 122 comprises a material that differs from a material in an adjacent portion 114 of the resonator cavity 110. Furthermore, an index of refraction of the material of the nanostructure 122 differs from an index of refraction of the adjacent portion 114 of the resonator cavity 110. For example, the material of the nanostructure 122 may be silicon (Si) having a refractive index of about 4.0 while the adjacent portion 114 of the resonator cavity 110 may be hollow and filled with air having a refractive index of about 1.0.

In another example, such as a solid state or semiconductor laser, the nanostructure 122 may be located in a slot or cavity formed in a substantially solid material the resonator cavity 110. For example, the solid state laser may have a resonator cavity 110 comprising one or more of gallium arsenide (GaAs) and aluminum gallium arsenide (AlGaAs) while the nanostructure may comprise Si or zinc oxide (ZnO). The slot or cavity facilitates movement of the nanostructure 122 within the otherwise solid material of the resonator cavity 110, for example.

In various other examples, the material of the nanostructure 122 may comprise diamond, other forms of carbon (e.g., graphene, carbon nanotubes, etc.), polymethylmethacrylate (PMMA), silicon dioxide (SiO₂), germanium (Ge), gallium arsenide (GaAs), aluminum gallium arsenide (AlGaAs), or any of a number of materials (e.g., glasses, crystals, other compound semiconductors, metals, organometallics, etc.) used with or in the construction of photonic devices such as lasers and optical transmission lines. A selection of a particular material for the nanostructure 122 depends on providing a refractive index difference and, as such, is dependent on specifics of the laser and more particularly the resonator cavity 110 to which it is applied. Further, the above example materials, while discussed with respect to FIG. 2, may be broadly applicable to all of the nanostructured resonance interactors 120 described herein.

As illustrated, the nanostructure 122 of the nanostructured resonance interactor 120 is movable relative to the optical path 112 of the resonator cavity 110. A double-headed arrow 108 illustrates a motion of the nanostructure 122 in FIG. 2 in response to vibration (i.e., illustrated as the double-headed arrow 106). In particular, the nanostructure 122 (i.e., of the nanostructured resonance interactor 120) is operably connected to respond to the vibration 106 in a manner that varies a thickness of the wedge shape that intersects the optical path 112. Further as illustrated, the nanostructure 122 is operably connected to a proof mass 124 that is also part of the nanostructured resonance interactor 120 of the example. Due to the operable connection, the vibration 106 causes the wedge shape of the nanostructure 122 to move in the directions of the double-headed arrow 108, e.g., up and down. The up-and-down motion results in a change in a thickness of the portion of the nanostructure 122 that intersects the optical path 112. For example, when the wedge-shaped nanostructure 122 moves upward (i.e., further into the optical path 112), a thickness of the optical path-intersecting portion of the nanostructure 122 increases. Likewise, when the wedge-shaped nanostructure 122 moves downward (i.e., further out of the optical path 112), the thickness of the optical-path intersecting portion of the nanostructure 122 decreases.

An amount, length or thickness of the material of the nanostructure 122 that intersects the optical path 112 in combination with the index of refraction difference between the material of the nanostructure 120 and the adjacent portion 114 of the resonator cavity 110 determines a propagation time of the optical signal along the optical path 112. The propagation time, in turn, establishes the effective optical length of the optical path 112. As such, the vibration-induced motion 108 of the nanostructure 120 produces a related, concomitant change in the effective optical length of the optical path 112.

In some examples, the effective optical length of the optical path 112 determines a frequency of the output signal 102 of the laser 104. Hence, vibration-induced motion 108 may produce a change or a variation in the output signal frequency (i.e., a frequency modulation). The frequency modulation produced is related to the vibration 106 experienced by the laser vibration sensor 100. Measuring the modulation of output signal frequency enables measurement of the vibration 106 that produced the frequency modulation.

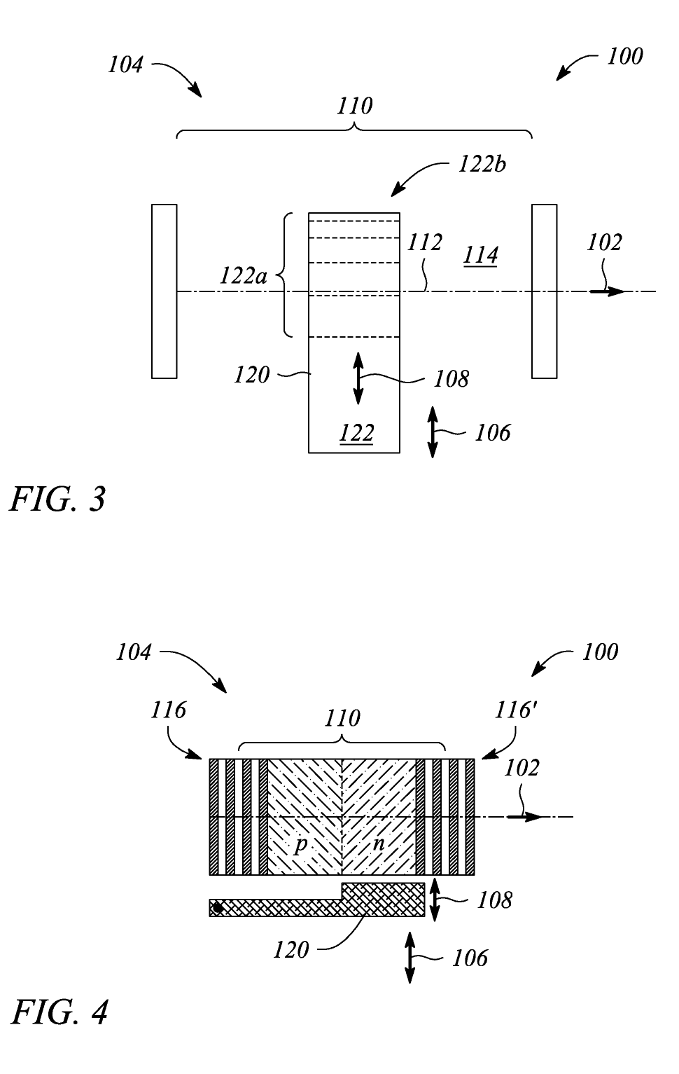

FIG. 3 illustrates a side view of a laser vibration sensor 100, according to an example of the principles described herein. In particular, as illustrated in FIG. 3, the nanostructured resonance interactor 120 comprises a nanostructure 122 having a material variation along a portion 122a of the nanostructure 122 in a vicinity of the optical path 112. In addition, in some examples the nanostructure 122 may also have an index of refraction that differs from an index of refraction of the adjacent portion 114 of the resonator cavity 110. The nanostructure 122 may be a nanowire or a bundle of nanowires, for example. The portion 122a in the vicinity of the optical path 112 comprises a material variation as a function of distance from a terminal end 122b of the nanostructure 122. The material variation may comprises one or more of a variation in an index of refraction, a variation in optical absorption or loss, and a variation in a reflectivity of the material. For example, the index of refraction may be graded from a relatively lower value at the terminal end 122b to a relatively higher value away from the terminal end 122b. As the nanostructure 122 undergoes vibration-induced motion 108 as a result of the vibration 106, different parts or areas within the portion 122a intersect the optical path 112. As a result, the vibration-induced motion 108 produce a change in the optical signal and likewise in the resonance due to the material variation. For example, if the material variation comprises a change the index of refraction, the vibration-induced motion 108 will produce a change in an effective path length of the optical path 112 as material regions with differing index of refraction move in and out of the optical path 112.

FIG. 4 illustrates a cross sectional top view of a laser vibration sensor 100, according to another example of the principles described herein. In particular, FIG. 4 illustrates an example of the laser vibration sensor 100 in which the nanostructured resonance interactor 120 indirectly interacts with the optical signal within the resonant cavity 110 of the laser 104. As illustrated in FIG. 4, the laser vibration sensor 100 comprises a laser 104 having a resonator cavity 110. For example, the laser 104 may comprise a solid-state semiconductor laser comprising a p-n junction and a pair of Bragg mirrors 116, 116′ that define the resonator cavity 110. The laser vibration sensor 100 further comprises a nanostructured resonance interactor 120 positioned adjacent to (e.g., along a side of) the resonator cavity 110.

Motion 108 of the nanostructured resonance interactor 120 in response to the vibration 106 changes a coupling between the nanostructured resonance interactor 120 and an evanescent field (e.g., fringing field) of the optical field within the resonant cavity 110. The motion 108 may be alternately toward and away from the resonator cavity 110, for example. The change in the coupling, in turn, modulates the characteristic of the optical field in the resonator cavity 110. The output signal 102 has a characteristic that is related to the characteristic of the optical filed within the resonator cavity 110. As such, the modulation of the optical field characteristic produces a modulation of the characteristic (e.g., frequency, phase, amplitude, etc.) of the optical signal 102 produced by the laser 104. In some examples, the nanostructured resonance interactor 120 illustrated in FIG. 4 may comprise a nanostructure (e.g., a nanorod or nanowire) position adjacent to the resonator cavity 110.

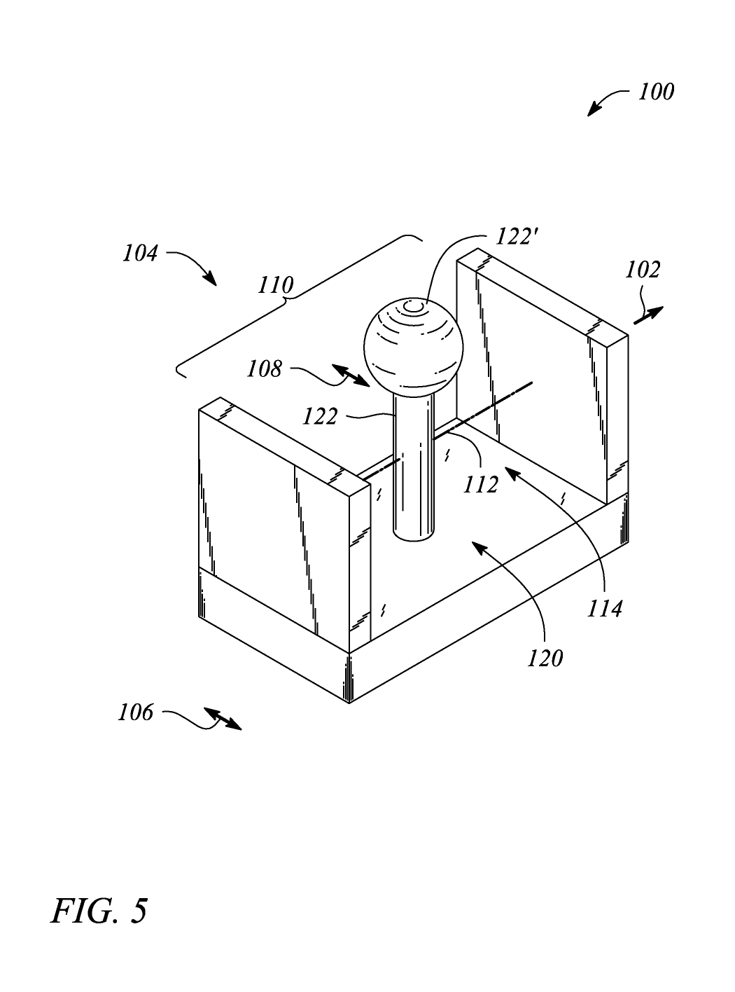

FIG. 5 illustrates a perspective view of a laser vibration sensor 100, according to another example of the principles described herein. In particular, FIG. 5 illustrates a perspective view within the resonant cavity 110 of the laser 104 wherein the nanostructured resonance interactor 120 comprises a nanowire 122. In some examples, the nanowire 122 may be substantially cylindrical in cross section (i.e., a substantially cylindrical nanowire). In other examples, the nanowire 122 may have another cross sectional shape such as, but not limited to, oval, triangular, rectangular, hexagonal, octagonal, or another polygonal shape. A material of the nanowire 122 has an index of refraction that differs from an index of refraction of an adjacent portion 114 of the resonator cavity 110. For example, the nanowire 122 may comprise zinc oxide (ZnO), Si or another relatively high refractive index material while the cavity 110 encloses one of a gas or a vacuum having a relatively lower refractive index.

The nanowire 122 is located in the resonant cavity 110 such that the nanowire 122 intersects an optical path 112 within the cavity 110. In some examples, the nanowire 122 may include a proof mass 122′ at a free or terminal end of the nanowire 122, as illustrated by way of example in FIG. 5. In other examples, a proof mass (not illustrated) may one of not be explicitly present, be a mass of the nanowire 122 that acts as the proof mass, or may be operably connected to the nanowire 122 in another manner relative to that illustrated in FIG. 4. For example (not illustrated), the proof mass may be connected to an end of the nanowire 122 that is outside of (and below, for example) the resonator cavity 110. In such a configuration, motion of the proof mass may be communicated to a portion of the nanowire 122 that intersects the optical path 112 (e.g., through a pivoting attachment point or hinge between the nanowire 122 and a wall of the resonator cavity 110), for example.

Regardless of the specific implementation, a vibration or acceleration experienced by the laser vibration sensor 100 illustrated in FIG. 5 causes the nanowire 122 to move. For example, the nanowire 122 may move back and forth in response to the vibration as indicated by the double-headed arrow 108 in FIG. 5. As the nanowire 122 moves, a greater or lesser amount of the nanowire 122 intersects the optical path 112 and an optical signal propagating along the path 112. As the amount of nanowire 122 intersecting the optical path 112 varies, characteristics of the optical signal are changed. The change in the characteristics of the optical signal traveling along the optical path 112 within the resonator cavity 110 may result in a change in a characteristic of the output signal 102 of the laser 104. For example, the effective length of the optical path 112 may vary due to the changing amount of material through which the optical signal must pass. A change in effective optical path length may translate into a change in an output frequency of the output signal 102.

In another example, movement 108 of the nanowire 122 in response to the vibration 106 may produce a variation in an amplitude of the optical signal within the resonator cavity 110. The amplitude variation may translate into a variation or modulation of an amplitude of the output signal 102 of the laser 104, for example. The amplitude variation may even be a variation from an ‘ON’ condition to an ‘OFF’ condition of the laser 104, in some examples. Such a variation may provide an ON-OFF keying (OOK) modulation, in response to the vibration. For example, the amplitude variation may cause a laser gain material of the laser 104 to transition above and below a lasing threshold to yield the OOK modulation. In other examples, modulation of either a phase or a polarization of the output signal 102 may be produced.

In some examples, the nanostructured resonance interactor 120 of the laser vibration sensor 100 comprises a plurality of structures that respond in a tuned or otherwise vibration-specific manner. The combined response of the plurality of structures (e.g., nanostructures) may enable the laser vibration sensor 100 to respond to a broadband of vibration frequencies. In addition, the tuned plurality of structures may allow the laser vibration sensor 100 to produce an output signal 102 that is tailored to specific applications, for example. For example, the laser vibration sensor 100 may be tailored to be frequency selective and respond to only predetermined frequencies or frequency ranges of the vibration 106.

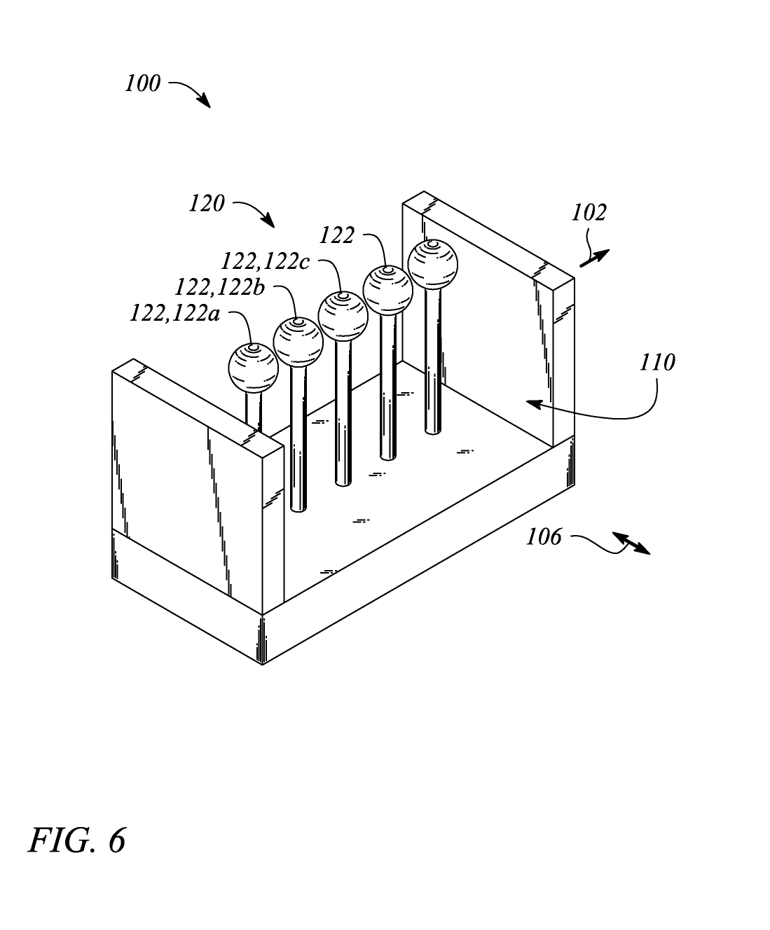

FIG. 6 illustrates a perspective view of a laser vibration sensor 100, according to another example of the principles described herein. In particular, the laser vibration sensor 100 illustrated in FIG. 6 depicts a nanostructured resonance interactor 120 that comprises a plurality of nanowires 122 within the resonant cavity 110. One or more nanowires 122 of the plurality may have a response to vibration that differs from other nanowires 122 of the plurality. For example, a first nanowire 122a may respond to vibrations 106 in a 1-10 Hz range while a second nanowire 122b may respond to vibrations 106 in a 10-100 Hz range. Together, the first and second nanowire 122a, 122b may cover a vibration range from 1-100 Hz, for example. In another example, a first nanowire 122a may respond to vibrations 106 in a 1-100 Hz range while a second nanowire 122b may respond to vibrations 106 in a 50-500 Hz range. A third nanowire 122c may similarly be tuned to respond to vibrations in the 200-1000 Hz range. Other frequency ranges and range overlaps may be employed without departing from the scope herein. A characteristic of the output signal 102 is affected by a vibration having a frequency that falls within any of the vibration ranges of the various nanowires 122 of the plurality.

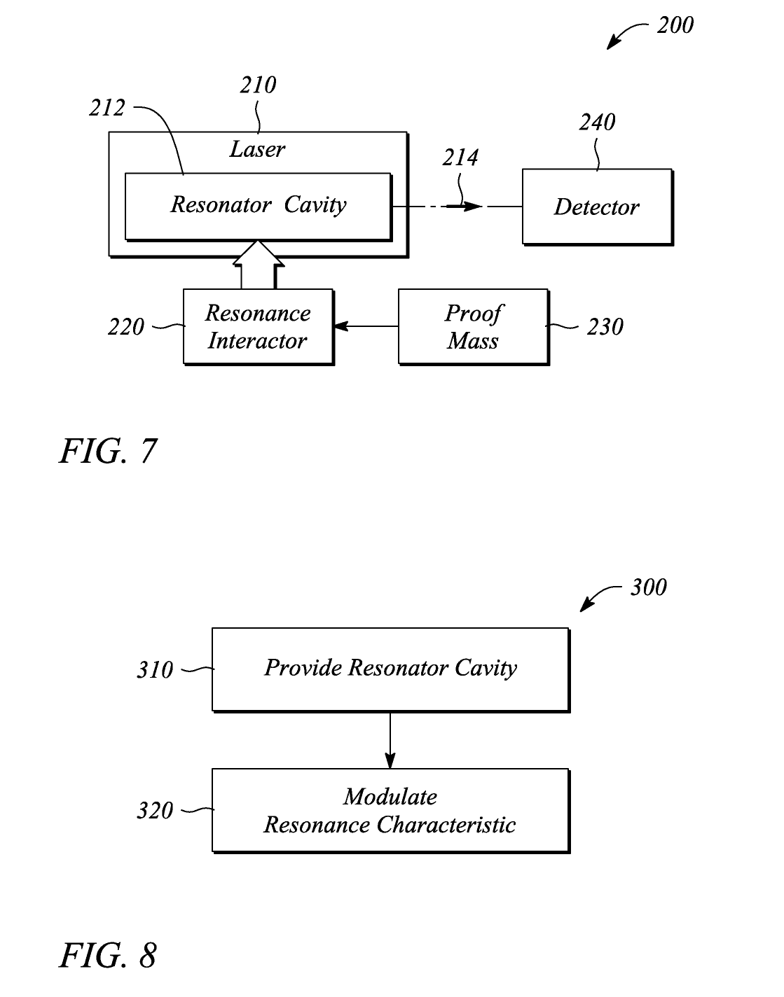

FIG. 7 illustrates a block diagram of laser vibration sensor system 200, according to an example of the principles described herein. The laser vibration sensor system 200 comprises a laser 210. The laser 210 comprises a resonator cavity 212 that exhibits a resonance. The resonance determines a characteristic of an output signal 214 of the laser 210. The laser 210 and resonator cavity 212 may be substantially similar to the laser 104 and the resonator cavity 110 described above with respect to the laser vibration sensor 100, according to some examples.

The laser vibration sensor system 200 further comprises a nanostructured resonance interactor 220. The nanostructured resonance interactor 220 modulates the resonance of the resonator cavity 212. The modulation is in response to a vibration. In some examples, the vibration may be a result of an acceleration. In some examples, the nanostructured resonance interactor 220 may be operably connected to a proof mass 230 to respond to the vibration. In other examples (not illustrated), there may be no proof mass or the nanostructured resonance interactor 220 itself may also act as the proof mass. The resonance modulation induces a change in the output signal characteristic determined by the resonance. In some examples, the nanostructured resonance interactor 220 may be substantially similar to the nanostructured resonance interactor 120 described above with respect to the laser vibration sensor 100.

The laser vibration sensor system 200 further comprises an output signal detector 240. The output signal detector 240 is configured to receive the output signal 214 of the laser 210. The output signal detector 240 is further configured to detect the output signal characteristic of the output signal 214 that is determined by the resonance. Since the resonance modulation is produced by or results from the vibration, the change in the detected output signal characteristic induced by the resonance modulation is representative of the vibration.

The output signal detector 240 is selected to be appropriate for detecting a particular output signal characteristic associated with the resonance modulation. For example, if the resonance modulation produces a change or modulation in a frequency of the output signal 102, the output signal detector 240 may be selected to be a frequency detector. An optical heterodyne detector may be employed as the output signal detector 240 to detect a frequency modulation, for example. The optical heterodyne detector may further comprise a reference laser (not illustrated) to ‘heterodyne’ with the output signal 214 of the laser 210. In another example, when the output signal characteristic associated with the resonance modulation is phase, an optical phase detector may be employed as the output signal detector 240. In another example, an optical amplitude detector comprising a simple detector diode may be used as the output signal detector 240 when the output signal characteristic is amplitude. Similarly, for polarization, a polarization detector may be used as the output signal detector 240, for example. Heterodyne, homodyne, phase sensitive and interferometric detection and post detection methods can all be employed to maximize a dynamic range, sensitivity and signal to noise ratio of the output signal 214 of the laser 210, according to various examples.

FIG. 8 illustrates a flow chart of a method 300 of vibration sensing, according to an example of the principles describe herein. The method 300 of vibration sensing comprises providing 310 a resonator cavity of a laser. Providing 310 a resonator cavity of a laser may comprise fabricating the laser on a substrate using semiconductor fabrication methods, for example. In another example, providing 310 a resonator cavity of a laser may comprise forming components of a fiber laser and assembling the components to produce the fiber laser having a resonator cavity. In yet another example, providing 310 a resonator cavity of a laser may comprise purchasing or otherwise acquiring a laser. Herein it is explicitly recognized that all lasers have a resonator cavity. Further, the laser may be substantially any laser including, but not limited to, the lasers described above. Specifically, the provided 310 resonator cavity of the laser may be substantially similar to the resonator cavity 110 of the laser 104 described above with respect the laser vibration sensor 100 and the resonator cavity 212 of the laser 210, described above with respect to the laser vibration sensor system 200.

The method 300 of vibration sensing further comprises modulating 320 a resonance characteristic of the resonator cavity. In particular, modulating 320 a resonance characteristic is in response to a vibration being sensed. In various examples, modulating 320 is provided by one or both of a movable nanostructural member that intersects an optical path within the resonator cavity and a movable nanostructural member that couples to an evanescent field of the resonator cavity. By definition herein, to “intersect an optical path” the movable nanostructural member must be located along but not at a terminus of the optical path within the resonator cavity. As such, the movable nanostructural member or nanostructure specifically is not and cannot be a mirror used to form the resonator cavity (e.g., mirrors of a Fabry-Perot resonator). The resonance characteristic modulation 320 may be substantially similar to any of the modulations described above with respect to the laser vibration sensor 100 and the laser vibration sensor system 200. In some examples, the resonator cavity may be provided 310 with a slot, a hollow or cavity that accommodates the movable nanostructural member within and facilitate movement with respect to the resonator cavity.

Thus, there have been described examples of a laser vibration sensor, a laser vibration sensor system and a method of vibration sensing that employ a vibration-related resonance interaction with a resonance of a resonator cavity of a laser. It should be understood that the above-described examples are merely illustrative of some of the many specific examples that represent the principles of what is claimed. Clearly, those skilled in the art can readily devise numerous other arrangements without departing from the scope defined by the following claims.

What is claimed is:

1. A laser vibration sensor comprising:
a resonator cavity of a laser, the resonator cavity having a resonance deterministic of a characteristic of an output signal of the laser; and
a nanostructured resonance interactor to modulate the resonance of the resonator cavity in response to a vibration, the nanostructured resonance interactor comprising a nanostructure,
wherein a change in the output signal characteristic induced by a resonance modulation is representative of the vibration in the nanostructure.

2. The laser vibration sensor of claim 1, wherein the nanostructure of the nanostructured resonance interactor is within the resonator cavity, the nanostructure intersecting an optical path of the resonator cavity.

3. The laser vibration sensor of claim 2, wherein the nanostructure within the resonator cavity comprises a substantially cylindrical nanowire of a material having an index of refraction that differs from an index of refraction of an adjacent portion of the resonator cavity, the nanowire being operably connected to a proof mass that, in response to the vibration, varies a portion of a diameter of the substantially cylindrical nanowire that intersects the optical path, the variable portion of the diameter changing an effective optical length of the optical path.

4. The laser vibration sensor of claim 2, wherein the nanostructure within the resonator cavity comprises a material that varies along a length of the nanostructure, the nanostructure being operably connected to a proof mass that, in response to the vibration, varies a portion of the nanostructure along a length of the nanostructure that intersects the optical path to variably affect the resonance.

5. The laser vibration sensor of claim 1, wherein the nanostructured resonance interactor comprises a nanostructure adjacent to an optical path of the resonator cavity to variably couple to an evanescent field of an optical signal within the optical path in response to the vibration, wherein a change in the evanescent field due to a change in the variable coupling affects the output signal characteristic.

6. The laser vibration sensor of claim 1, wherein the output signal characteristic comprises a frequency, the change in the output signal characteristic induced by the resonance modulation being a change in the frequency.

7. The laser vibration sensor of claim 1, wherein the output signal characteristic comprises an amplitude, the change in the output signal characteristic induced by the resonance modulation being a change in the amplitude.

8. A laser vibration sensor system that employs the laser vibration sensor of claim 1, the laser vibration sensor system further comprising an output signal detector to receive the output signal and to detect the change in the output signal characteristic.

9. The laser vibration sensor system of claim 8, wherein the output signal detector comprises a heterodyne detector, the output signal characteristic being frequency.

10. A laser vibration sensor system comprising:
a laser having a resonator cavity, the resonator cavity exhibiting a resonance that determines a characteristic of an output signal of the laser;
a nanostructured resonance interactor to modulate the resonance of the resonator cavity in response to a vibration, the nanostructured resonance interactor comprising a nanostructure and being operably connected to a proof mass to respond to the vibration; and
an output signal detector to receive the output signal of the laser and detect the output signal characteristic,
wherein a change in the detected output signal characteristic induced by the resonance modulation is representative of the vibration of the nanostructure.

11. The laser vibration sensor system of claim 10, wherein the nanostructure of the nanostructured resonance interactor comprises a nanostructure within the resonator cavity that is operably connected to the proof mass, the nanostructure intersecting an optical path of the resonator cavity.

12. The laser vibration sensor system of claim 11, wherein the nanostructure within the resonator cavity comprises a nanowire and the proof mass comprises a mass affixed to a terminal end of the nanowire.

13. The laser vibration sensor system of claim 11, wherein the nanostructure within the resonator cavity comprises a material having an index of refraction that differs from an index of refraction of an adjacent portion of the resonator cavity, the operable connection between the proof mass and the nanostructure inducing a variation in a thickness of the nanostructure intersecting the optical path in response to the vibration.

14. The laser vibration sensor system of claim 10, wherein the output signal detector comprises a heterodyne detector, the output signal characteristic being frequency.

15. The laser vibration sensor system of claim 10, wherein the output signal detector comprises an amplitude detector, the output signal characteristic being amplitude.

16. The laser vibration sensor system of claim 10, wherein the nanostructured resonance interactor comprises a plurality of structures that respond in a vibration-specific manner.

17. A method of vibration sensing, the method comprising:
providing a resonator cavity of a laser; and
modulating a resonance characteristic of the resonator cavity in response to a vibration being sensed,
wherein modulating the resonance characteristic is provided by one or both of a movable nanostructural member that intersects an optical path within the resonator cavity and a movable nanostructural member that couples to an evanescent field of the resonator cavity.

18. The method of vibration sensing of claim 17, wherein the movable nanostructural member that intersects an optical path comprises a material that varies along a length of the nanostructure, modulating in response to the vibration being provided by a variation of a portion of the nanostructure along a length of the nanostructure that intersects the optical path in response to the vibration being sensed.

19. The method of vibration sensing of claim 17, further comprising:
detecting an the output signal produced by the laser using a signal detector; and
determining an effect of modulating the resonance characteristic on the output signal.

20. The method of vibration sensing of claim 17, wherein modulating a resonance characteristic produces a change in an effective path length within the resonator cavity that yields a variation in a frequency of an output signal of the laser in response to the vibration being sensed.
